(19) United States
(12) Patent Application Publication
(10) Pub. No.: US 2026/0070554 A1
(43) Pub. Date: Mar. 12, 2026

(54) MOBILE OBJECT CONTROL DEVICE, MOBILE OBJECT CONTROL METHOD, AND STORAGE MEDIUM

(71) Applicant: HONDA MOTOR CO., LTD., Tokyo (JP)

(72) Inventor: Sho Tamura, Tokyo (JP)

(21) Appl. No.: 19/312,341

(22) Filed: Aug. 28, 2025

(30) Foreign Application Priority Data
Sep. 12, 2024 (JP) 2024-158387

(51) Int. Cl. B60W 30/18; B60W 60/00; G06V 10/74; G06V 20/56

(52) U.S. Cl. CPC B60W 30/18154; G06V 10/74; G06V 20/588; B60W 60/001; B60W 2420/403; B60W 2420/408; B60W 2552/05; B60W 2552/50; B60W 2552/53; B60W 2554/4041; B60W 2554/802; B60W 2556/20; B60W 2556/40

(57) ABSTRACT

A mobile object control device includes a first recognizer configured to recognize a target and a first marking for defining a movement path located in a travel direction of a mobile object using an image captured by an imager, a second recognizer configured to recognize a second marking for defining a movement path near the mobile object from map information on the basis of position information of the mobile object, a third recognizer configured to recognize the target in the travel direction using a radar device, a determiner configured to determine whether or not the first and second markings match, and a movement controller configured to control movement of the mobile object on the basis of a determination result. When the third recognizer recognizes the target, the movement controller controls movement of the mobile object in accordance with the movement path identified on the basis of the recognized target.

### CROSS-REFERENCE TO RELATED APPLICATION

Priority is claimed on Japanese Patent Application No. 2024-158387, filed Sep. 12, 2024, the content of which is incorporated herein by reference.

### BACKGROUND

### Field of the Invention

The present invention relates to a mobile object control device, a mobile object control method, and a storage medium.

### Description of Related Art

In recent years, efforts to provide access to sustainable transportation systems have been increasingly active in consideration of vulnerable individuals among participants in transportation. For this realization, research and development efforts are focused on further improving the safety and convenience of transportation through research and development related to automated driving technology. In this regard, conventional technology for increasing reliability when a road sign recognized from an image matches a road sign stored in a storage in a surrounding recognition process of a mobile object and determining the road sign stored in the storage as a road sign corresponding to a current position when the reliability is greater than or equal to a predetermined value is known (e.g., Japanese Unexamined Patent Application, First Publication No. 2019-212188).

### SUMMARY

Meanwhile, in conventional automated driving technologies, because the accuracy of recognizing surroundings using images varies with a surrounding situation of a mobile object or the like, there are cases where a movement path cannot be accurately identified and appropriate movement control cannot be executed.

The present application has been made in consideration of such circumstances and an objective of the present application is to provide a mobile object control device, a mobile object control method, and a storage medium that can enable more appropriate movement control to be executed in accordance with a recognition situation of surroundings of a mobile object. Also, the present invention contributes to the development of a sustainable transportation system.

A mobile object control device, a mobile object control method, and a storage medium according to the present invention adopt the following configurations.

(1): According to an aspect of the present invention, there is provided a mobile object control device including: a first recognizer configured to recognize a target and a first marking for defining a movement path located in a travel direction of a mobile object using an image captured by an imager; a second recognizer configured to recognize a second marking for defining a movement path near the mobile object from map information on the basis of position information of the mobile object; a third recognizer configured to recognize the target in the travel direction of the mobile object using a radar device; a determiner configured to determine whether or not the first marking matches the second marking; and a movement controller configured to control movement of the mobile object on the basis of a determination result of the determiner, wherein, when the third recognizer recognizes the target not recognized by the first recognizer, the movement controller controls movement of the mobile object in accordance with the movement path identified on the basis of the target recognized by the third recognizer.

(2): In the above-described aspect (1), the movement controller controls the movement of the mobile object in accordance with the movement path identified on the basis of the target recognized by the third recognizer when the target recognized by the third recognizer is recognized on an inward side of the movement path in a width direction as seen from the mobile object, compared to the target recognized by the first recognizer.

(3): In the above-described aspect (2), the target recognized by the third recognizer is located farther away from the mobile object than the first marking or the target recognized by the first recognizer.

(4): In the above-described aspect (3), the target recognized by the third recognizer includes a preceding mobile object moving in front of the mobile object.

(5): In the above-described aspect (3), the target recognized by the third recognizer includes a target (a nose target) indicating a branch point, a merge point, or a construction segment end of the movement path.

(6): In the above-described aspect (3), the target recognized by the third recognizer includes a tunnel sidewall.

(7): In the above-described aspect (1), the determiner determines whether or not recognition accuracy of the first recognizer has deteriorated, and the movement controller controls the movement of the mobile object in accordance with the movement path identified using the target recognized by the third recognizer when it is determined that the recognition accuracy has deteriorated.

(8): In the above-described aspect (1), the movement controller controls the movement of the mobile object on the basis of a marking located within a predetermined distance from the target recognized by the third recognizer.

(9): In the above-described aspect (8), the movement controller controls the movement of the mobile object on the basis of the marking when the marking is located within the predetermined distance from the target recognized by the third recognizer even if the determiner determines that the first marking matches the second marking.

(10): In the above-described aspect (8), the movement controller controls the movement of the mobile object on the basis of the marking when the marking is located within the predetermined distance from the target recognized by the third recognizer even if positions of the first marking and the target recognized by the first recognizer are within the predetermined distance.

(11): In the above-described aspect (1), the movement controller adjusts priorities of a recognition result of the first recognizer and a recognition result of the third recognizer in accordance with a distance between the target located in the travel direction of the mobile object and the mobile object and controls the movement of the mobile object in accordance with the movement path identified on the basis of a recognition result of higher priority.

(12): According to another aspect of the present invention, there is provided a mobile object control method including: recognizing, by a computer, a target and a first marking for defining a movement path located in a travel direction of a mobile object using an image captured by an imager; recognizing, by the computer, a second marking for defining a movement path near the mobile object from map information on the basis of position information of the mobile object; recognizing, by the computer, the target in the travel direction of the mobile object using a radar device; determining, by the computer, whether or not the first marking matches the second marking; controlling, by the computer, movement of the mobile object on the basis of a determination result; and controlling, by the computer, movement of the mobile object in accordance with the movement path identified on the basis of the target recognized using the radar device when the target not recognized by a recognition process using the image is recognized by a recognition process using the radar device.

(13): According to yet another aspect of the present invention, there is provided a computer-readable non-transitory storage medium storing a program for causing a computer to: recognize a target and a first marking for defining a movement path located in a travel direction of a mobile object using an image captured by an imager; recognize a second marking for defining a movement path near the mobile object from map information on the basis of position information of the mobile object; recognize the target in the travel direction of the mobile object using a radar device; determine whether or not the first marking matches the second marking; control movement of the mobile object on the basis of a determination result; and control movement of the mobile object in accordance with the movement path identified on the basis of the target recognized using the radar device when the target not recognized by a recognition process using the image is recognized by a recognition process using the radar device.

According to the above-described aspects (1) to (13), it is possible to execute more appropriate movement control in accordance with a recognition situation of surroundings of a mobile object.

### BRIEF DESCRIPTION OF THE DRAWINGS

FIG. 1 is a configuration diagram of a vehicle system including a mobile object control device according to an embodiment.

FIG. 2 is a functional configuration diagram of a first controller and a second controller.

FIG. 3 is a diagram showing an example of a road (a movement path) along which a host vehicle M travels.

FIG. 4 is an explanatory diagram of a process of identifying a travel lane on the basis of recognition accuracy.

FIG. 5 is a flowchart showing an example of a flow of a travel control process in the embodiment.

### DESCRIPTION OF EMBODIMENTS

Hereinafter, embodiments of a mobile object control device, a mobile object control method, and a storage medium of the present invention will be described with reference to the drawings. Hereinafter, an embodiment in which an example of a mobile object is a vehicle and the mobile object control device is applied to an automated driving vehicle will be described as an example. For example, automated driving is a process of executing driving control by automatically controlling one or both of the vehicle's steering and speed. For example, the above-described driving control may include various types of driving control such as a lane keeping assistance system (LKAS), automated lane change (ALC), adaptive cruise control system (ACC), traffic jam pilot (TJP), and collision mitigation brake system (CMBS). An automated driving vehicle may be driven by a manual operation (so-called manual driving) of a user (e.g., an occupant) of a vehicle. In addition to vehicles, the mobile object may include, for example, a watercraft that can move on the ground (on the road) like a hovercraft, an aircraft that can travel on the road, a stand-up vehicle having a motive power unit, and the like.

### [Overall Configuration]

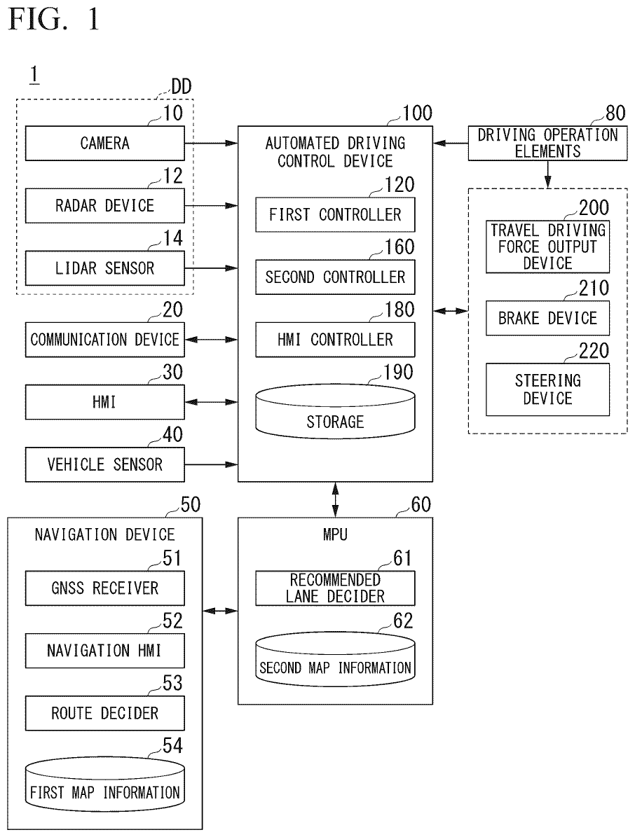

FIG. 1 is a configuration diagram of a vehicle system 1 including the mobile object control device according to the present embodiment. A vehicle (hereinafter referred to as a host vehicle M) in which the vehicle system 1 is mounted is, for example, a micromobility or a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a battery (a storage battery) such as a secondary battery or a fuel cell is discharged.

For example, the vehicle system 1 includes a camera 10, a radar device 12, a light detection and ranging (LIDAR) sensor 14, a communication device 20, a human machine interface (HMI) 30, a vehicle sensor 40, a navigation device 50, a map positioning unit (MPU) 60, driving operation elements 80, an automated driving control device 100, a travel driving force output device 200, a brake device 210, and a steering device 220. Such devices and equipment are connected to each other by a multiplex communication line such as a controller area network (CAN) communication line, a serial communication line, or a wireless communication network. The configuration shown in FIG. 1 is merely an example and some of the constituent elements may be omitted or other constituent elements may be further added. A combination of the camera 10, the radar device 12, and the LIDAR sensor 14 is an example of a “detection device DD.” The HMI 30 is an example of an “output device.” The automated driving control device 100 is an example of a “mobile object control device.”

For example, the camera 10 is a digital camera using a solid-state imaging element such as a charge-coupled device (CCD) or a complementary metal oxide semiconductor (CMOS). The camera 10 is attached to any location on the host vehicle M in which the vehicle system 1 is mounted. For example, when the view in front of the host vehicle M is imaged, the camera 10 is attached to an upper part of a front windshield, a rear surface of a rearview mirror, a front part of a vehicle body, or the like. When the view to the rear of the host vehicle M is imaged, the camera 10 is attached to an upper part of a rear windshield, a back door, or the like. When the views to the side of the host vehicle M are imaged, the camera 10 is attached to a door mirror, or the like. For example, the camera 10 periodically and iteratively images the surroundings of the host vehicle M. The camera 10 may be a stereo camera.

The radar device 12 radiates radio waves (radar) such as millimeter waves around the host vehicle M and detects at least a position of a physical object (a distance from the physical object and a direction of the physical object) by detecting radio waves (reflected waves) reflected by the physical object near the host vehicle M. The radar device 12 is attached to any location on the host vehicle M. The radar device 12 may detect a position and a speed of the physical object in a frequency-modulated continuous wave (FM-CW) scheme.

The LIDAR sensor 14 radiates light to the vicinity of the host vehicle M and measures scattered light. The LIDAR sensor 14 detects a distance from an object on the basis of time from light emission to light reception. The radiated light is, for example, pulsed laser light. The LIDAR sensor 14 is attached to any location on the host vehicle M.

The communication device 20, for example, communicates with another vehicle located in the vicinity of the host vehicle M, a terminal device of a user using the host vehicle M, or various types of server devices using, for example, a cellular network, a Wi-Fi network, Bluetooth (registered trademark), dedicated short-range communication (DSRC), a local area network (LAN), a wide area network (WAN), a network such as the Internet, or the like.

The HMI 30 outputs various types of information to occupants (including the driver) of the host vehicle M and receives input operations from the occupants. The HMI 30 includes, for example, various types of display devices, speakers, touch panels, switches, keys, microphones, and the like.

The vehicle sensor 40 includes a vehicle speed sensor configured to detect the speed of the host vehicle M, an acceleration sensor configured to detect acceleration, a yaw rate sensor configured to detect a yaw rate (e.g., a rotational angular velocity around a vertical axis passing through the center of gravity of the host vehicle M), a direction sensor configured to detect the direction of the host vehicle M, and the like. The vehicle sensor 40 may include a position sensor configured to detect the position of the host vehicle M. The position sensor is, for example, a sensor configured to acquire position information (longitude/latitude information) from a Global Positioning System (GPS) device. The position sensor may be a sensor configured to acquire position information using the global navigation satellite system (GNSS) receiver 51 of the navigation device 50. The vehicle sensor 40 may derive the speed of the host vehicle M from a position information difference (i.e., a distance) at a predetermined time in the position sensor. A sensor for acquiring weather information (e.g., a humidity sensor or a rain sensor) may be provided in the vehicle sensor 40. A detection result of the vehicle sensor 40 is output to the automated driving control device 100.

For example, the navigation device 50 includes the GNSS receiver 51, a navigation HMI 52, and a route decider 53. The navigation device 50 stores first map information 54 in a storage device such as a hard disk drive (HDD) or a flash memory. The GNSS receiver 51 identifies a position of the host vehicle M on the basis of a signal received from a GNSS satellite. The position of the host vehicle M may be identified or complemented by an inertial navigation system (INS) using an output of the vehicle sensor 40. The navigation HMI 52 includes a display device, a speaker, a touch panel, a key, and the like. The GNSS receiver 51 may be provided in the vehicle sensor 40. The navigation HMI 52 may be partly or wholly shared with the above-described HMI 30. For example, the route decider 53 decides a route (hereinafter referred to as a route on a map) from the position of the host vehicle M identified by the GNSS receiver 51 (or any input position) to a destination input by the occupant using the navigation HMI 52 with reference to the first map information 54. The first map information 54 is, for example, information in which a road shape is expressed by a link indicating a road (an example of a movement path) and nodes connected by the link. The first map information 54 may include point of interest (POI) information, and the like. The route on the map is output to the MPU 60. The navigation device 50 may provide route guidance using the navigation HMI 52 on the basis of the route on the map. The navigation device 50 may transmit a current position and a destination to a navigation server via the communication device 20 and acquire a route equivalent to the route on the map from the navigation server. The navigation device 50 outputs a decided route on the map to the MPU 60.

For example, the MPU 60 includes a recommended lane decider 61 and holds second map information 62 in a storage device such as an HDD or a flash memory. The recommended lane decider 61 divides the route on the map provided from the navigation device 50 into a plurality of blocks (e.g., divides the route every 100 [m] in a travel direction of the vehicle), and decides a recommended lane for each block with reference to the second map information 62. For example, the recommended lane decider 61 decides in what lane numbered from the left the vehicle will travel. The recommended lane decider 61 decides the recommended lane so that the host vehicle M can travel along a reasonable route for traveling to a branching destination when there is a branch point on the route on the map.

The second map information 62 is map information with higher accuracy than the first map information 54. The second map information 62 includes, for example, the number of lanes (the number of movement paths), a type and shape of road marking (hereinafter referred to as marking), information about the center of a lane, information about a road boundary, and the like. The second map information 62 may include information about whether or not the road boundary is a boundary (a physical boundary) including a structure in which the passage (including crossing and contacting) of a vehicle is impossible. Examples of physical boundaries include guardrails, curbs, median strips, fences, sidewalls of tunnels, nose targets (soft noses and hard noses), and the like. The term “passage is impossible” may include the presence of steps that are low enough to pass if the vehicle is allowed to vibrate, which would not normally occur. The second map information 62 may include road shape information, traffic regulation information, address information (addresses and postal codes), facility information, parking lot information, telephone number information, and the like. The road shape information is, for example, the curvature of a road (which may be rephrased as a radius of curvature; the same is true below), a road width, a road surface gradient, a branch point, a merge point, and the like. The second map information 62 may be updated at any time by the communication device 20 communicating with an external device. The first map information 54 and the second map information 62 may be integrated and provided as map information. The map information may be stored in the storage 190.

The driving operation elements 80 include, for example, a steering wheel, an accelerator pedal, and a brake pedal. The driving operation elements 80 may also include a shift lever, a variant steering wheel, a joystick, and other operation elements. An operation detector is attached to each operation element of the driving operation elements 80, for example, to detect an amount of operation on the operation element by the driver or the presence or absence of operation. The operation detector detects, for example, a steering angle and steering torque of the steering wheel, an amount of depression of the accelerator pedal or the brake pedal, and the like. Also, the operation detector outputs the detection result to the automated driving control device 100 or some or all of the travel driving force output device 200, the brake device 210, and the steering device 220.

The automated driving control device 100 executes various types of driving control belonging to automated driving with respect to the host vehicle M. The automated driving control device 100 includes, for example, a first controller 120, a second controller 160, an HMI controller 180, and a storage 190. Each of the first controller 120, the second controller 160, and the HMI controller 180 is implemented, for example, by a hardware processor such as a central processing unit (CPU) executing a program (software). Also, some or all of the above constituent elements may be implemented by hardware (including a circuit; circuitry) such as a large-scale integration (LSI) circuit, an application-specific integrated circuit (ASIC), a field-programmable gate array (FPGA), a graphics processing unit (GPU), or a system on chip (SOC) or may be implemented by software and hardware in cooperation. The above-described program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like.

The storage 190 may be implemented by the above-described various storage devices an electrically erasable programmable read-only memory (EEPROM), a read-only memory (ROM), a random-access memory (RAM), or the like. The storage 190 stores, for example, various other types of information, programs, and the like in the embodiment. The storage 190 may store map information (the first map information 54 and the second map information 62).

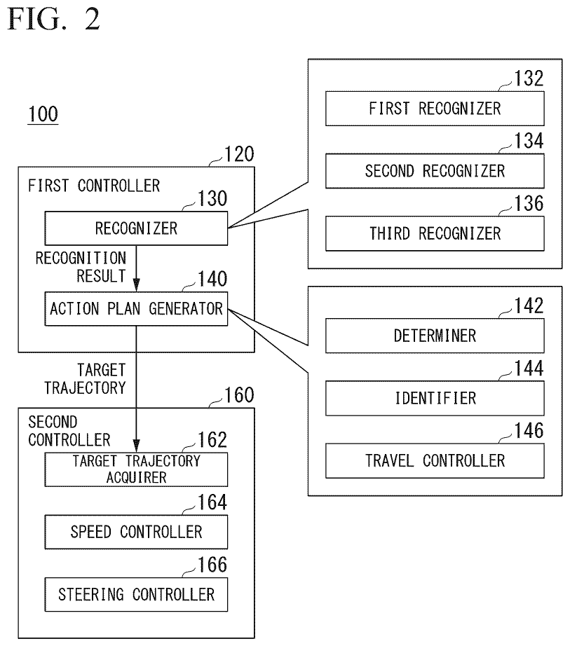

FIG. 2 is a functional configuration diagram of the first controller 120 and the second controller 160. The first controller 120 includes, for example, a recognizer 130 and an action plan generator 140. The first controller 120 implements, for example, a function of artificial intelligence (AI) and a function of a predetermined model in parallel. For example, an “intersection recognition” function may be implemented by executing intersection recognition based on deep learning or the like and recognition based on previously given conditions (signals, road signs, or the like, with which pattern matching is possible) in parallel and performing comprehensive evaluation by assigning scores to both recognitions. Thereby, the reliability of automated driving is secured. The first controller 120 executes control related to automated driving of the host vehicle M on the basis of, for example, instructions from the MPU 60, the HMI controller 180, or the like.

The recognizer 130 recognizes a surrounding situation of the host vehicle M on the basis of a detection result of the detection device DD (information input from the camera 10, the radar device 12, and the LIDAR sensor 14 via the physical object recognition device 16). For example, the recognizer 130 performs a sensor fusion process on some or all of the detection results of the camera 10, the radar device 12, and the LIDAR sensor 14 to recognize the position (relative position), size, speed (relative speed), acceleration, and the like of a target (a physical object) located in the vicinity of the host vehicle M (within a predetermined distance from the host vehicle M). Targets recognized by the recognizer 130 may include, for example, obstacles such as signs temporarily placed on the road and traffic participants such as other vehicles, pedestrians, bicycles, and the like in addition to physical boundaries (e.g., physical boundaries included in map information) that divide the road (movement path). The position of the target, for example, is recognized as a position on absolute coordinates with a representative point (the center of gravity, the center of drive shaft, or the like) of the host vehicle M as the origin, and is used for control. The position of the target may be indicated by a representative point such as the center of gravity or a corner of the target or may be indicated by an area that has been represented. The “state” of the target may include, for example, the acceleration or jerk of the mobile object, or the “action state” (e.g., whether or not another vehicle is changing lanes or is about to change lanes) when the target is a mobile object such as another vehicle.

The recognizer 130 recognizes, for example, a stop line, a red light, a toll booth, other road events, road signs, and markings drawn on the road (e.g., speed limits), and the like. The recognizer 130 includes, for example, a first recognizer 132, a second recognizer 134, and a third recognizer 136. The details of these functions will be described below.

The action plan generator 140 generates an action plan for causing the host vehicle M to travel according to automated driving on the basis of a recognition result of the recognizer 130 or the like. For example, the action plan generator 140 generates a future target trajectory (target travel route) along which the host vehicle M will automatically travel (independently of the driver's operation) so that the host vehicle M can generally travel in the recommended lane decided by the recommended lane decider 61 and further take an action for a surrounding situation of the host vehicle M on the basis of a nearby road shape, a marking recognition result, or the like based on the recognition result of the recognizer 130 or a current position of the host vehicle M acquired from map information. For example, the target trajectory includes a speed element. For example, the target trajectory is represented by sequentially arranging points (trajectory points) at which the host vehicle M is required to arrive. The trajectory points are points at which the host vehicle M is required to arrive for each predetermined traveling distance (e.g., about several meters [m]) in a distance along a road. In addition, a target speed and target acceleration for each predetermined sampling time (e.g., about 0.x [sec] where x is a decimal number) is generated as a part of the target trajectory. Also, the trajectory point may be a position where the host vehicle M is required to arrive at the sampling time for each predetermined sampling time. In this case, information of the target speed and the target acceleration is represented by an interval between the trajectory points.

The action plan generator 140 may set an automated driving event when the target trajectory is generated. The events include, for example, a lane departure suppression event for causing the host vehicle M to travel so that the host vehicle Mis prevented from departing the lane, a constant speed driving event in which the host vehicle M travels in the same lane at a constant speed, a tracking driving event for causing the host vehicle M to track another vehicle located within a predetermined distance (e.g., within 100 [m]) in front of the host vehicle M and closest to the host vehicle M, a lane change event for causing the host vehicle M to make a lane change from a host vehicle lane to an adjacent lane, a branching event for causing the host vehicle M to move to a lane in a destination direction at a branch point of a road, a merging event for causing the host vehicle M to move to a lane of a main road at a merge point, a takeover event for ending automated driving and switching driving to manual driving, and the like. The events may include, for example, an overtaking event in which the host vehicle M first makes a lane change to an adjacent lane, overtakes the preceding vehicle in the adjacent lane, and then makes a lane change to the original lane, an avoidance event for causing the host vehicle M to perform at least one of braking and steering to avoid an obstacle in front of the host vehicle M, and the like.

The action plan generator 140, for example, may change an event already decided for a current segment to another event or set a new event for the current segment, in accordance with a surrounding situation of the host vehicle M recognized when the host vehicle M is traveling. The action plan generator 140 may change an event already set for the current segment to another event or set a new event for the current segment, in accordance with an operation of the occupant on the HMI 30. The action plan generator 140 generates a target trajectory according to the set event.

The action plan generator 140 includes, for example, a determiner 142, an identifier 144, and a travel controller 146. The travel controller 146 is an example of a “movement controller.” The functions of these constituent elements will be described in detail below.

The second controller 160 controls the travel driving force output device 200, the brake device 210, and the steering device 220 so that the host vehicle M passes through the target trajectory generated by the action plan generator 140 at a scheduled time.

The second controller 160 includes, for example, a target trajectory acquirer 162, a speed controller 164, and a steering controller 166. The target trajectory acquirer 162 acquires information about a target trajectory (trajectory points) generated by the action plan generator 140 and causes a memory (not shown) to store the information. The speed controller 164 controls the travel driving force output device 200 or the brake device 210 on the basis of the speed element associated with the target trajectory stored in the memory. The steering controller 166 controls the steering device 220 in accordance with a degree of curvature of the target trajectory stored in the memory. The processes of the speed controller 164 and the steering controller 166, for example, are implemented by a combination of feedforward control and feedback control. As an example, the steering controller 166 executes a combination of feedforward control according to the curvature of the road in front of the host vehicle M and feedback control based on the deviation from the target trajectory.

Returning to FIG. 1, the HMI controller 180 notifies the occupant of predetermined information through the HMI 30 or receives information input by the HMI 30. The predetermined information includes, for example, information about traveling of the host vehicle M such as information about the state of the host vehicle M and information about driving control. The information about the state of the host vehicle M includes, for example, a speed, an engine speed, a shift position, and the like of the host vehicle M. Information about the driving control includes, for example, the presence or absence of the execution of driving control based on automated driving, information for asking about whether or not to start the automated driving, information about a driving control situation based on the automated driving, information about an automation level, information for prompting the driver to perform driving when driving is switched from the automated driving to the manual driving, and the like. The predetermined information may include information about a surrounding situation recognized by the detection device DD. The predetermined information may include information irrelevant to traveling of the host vehicle M, such as content (e.g., movies) stored in a storage medium such as a TV program or a DVD. The predetermined information may include, for example, information about the current position and destination in automated driving and the remaining amount of fuel of the host vehicle M. The HMI controller 180 may output the information received by the HMI 30 to the communication device 20, the navigation device 50, the first controller 120, and the like.

The HMI controller 180 may cause the HMI 30 to output inquiry information for the occupant, processing results of the first controller 120 and the second controller 160, and the like. The HMI controller 180 may transmit various types of information to be output by the HMI 30 to a terminal device used by the occupant of the host vehicle M via the communication device 20.

The travel driving force output device 200 outputs a travel driving force (torque) for enabling the traveling of the host vehicle M to driving wheels. For example, the travel driving force output device 200 includes a combination of an internal combustion engine, an electric motor, a transmission, and the like, and an electronic control unit (ECU) that controls the internal combustion engine, the electric motor, the transmission, and the like. The ECU controls the above-described constituent elements in accordance with information input from the second controller 160 or information input from the accelerator pedal of the driving operation element 80.

For example, the brake device 210 includes a brake caliper, a cylinder configured to transfer hydraulic pressure to the brake caliper, an electric motor configured to generate hydraulic pressure in the cylinder, and a brake ECU. The brake ECU controls the electric motor in accordance with the information input from the second controller 160 or the information input from the brake pedal of the driving operation element 80 so that brake torque according to a braking operation is output to each wheel. The brake device 210 may include a mechanism configured to transfer the hydraulic pressure generated according to an operation on the brake pedal to the cylinder via a master cylinder as a backup. The brake device 210 is not limited to the above-described configuration and may be an electronically controlled hydraulic brake device configured to control an actuator in accordance with information input from the second controller 160 and transfer the hydraulic pressure of the master cylinder to the cylinder.

For example, the steering device 220 includes a steering ECU and an electric motor. For example, the electric motor changes a direction of steerable wheels by applying a force to a rack and pinion mechanism. The steering ECU drives the electric motor in accordance with the information input from the second controller 160 or the information input from the steering wheel that is the driving operation element 80 to change the direction of the steerable wheels.

### [Recognizer and Action Plan Generator]

Next, functions of the recognizer 130 (mainly, the first recognizer 132, the second recognizer 134, and the third recognizer 136) and the action plan generator 140 (mainly, the determiner 142, the identifier 144, and the travel controller 146) will be described in detail. Hereinafter, travel control for the host vehicle M will also be described.

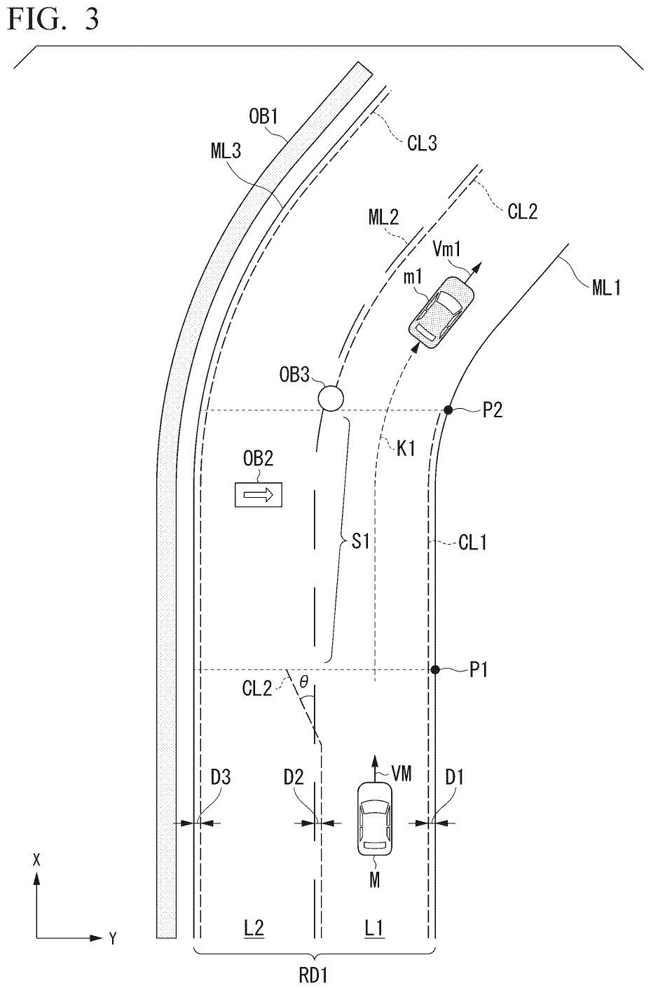

FIG. 3 is a diagram showing an example of a road (a movement path) along which the host vehicle M travels. In the example of FIG. 3, markings CL1 to CL3 recognized by the camera 10 and markings ML1 to ML3 obtained from map information (e.g., the second map information 62) on the basis of the position information of the host vehicle M are shown. A road RD1 shown in FIG. 3 has two lanes L1 and L2 in which the vehicle can travel in the same direction, and the lane L1 is defined by the markings ML1 and ML2 and the lane L2 is defined by the markings ML2 and ML3 in the map information. In the example of FIG. 3, the markings CL1 to CL3 are examples of a “first marking” and the markings ML1 to ML3 are examples of a “second marking.” Hereinafter, the markings CL1 to CL3 may be referred to as “camera markings CL1 to CL3” and the markings ML1 to ML3 may be referred to as “map markings ML1 to ML3.” When the camera markings CL1 to CL3 are not individually distinguished, they may simply be referred to as “camera markings CL.” When the map markings ML1 to ML3 are not individually distinguished, they may simply be referred to as “map markings ML.”

In the example of FIG. 3, a target (e.g., a physical boundary such as a guardrail) OB1 is located in an extension direction of the lane L2 on the left side (farther outside) of the road RD1 as seen from the lane L1 in the travelable direction (the X-axis direction in the drawing). Furthermore, in the example of FIG. 3, in a segment S1 from points P1 to P2 on the road RD1, because the lane L2 side is under road construction (or in front of a construction area), actual markings for defining the lane L1 and the lane L2 are not drawn and a target (e.g., a signboard) OB2 is installed on the lane L2 to inform drivers of nearby vehicles that construction is underway or to prompt the driver to travel in the lane L1. Furthermore, in the example of FIG. 3, a target (e.g., a soft nose) OB3 indicating an end of a branch (or an end of the construction segment) is installed. The targets OB2 and OB3 are located on an inward side of the target OB1 in a width direction (a lateral direction) of the road RD1 as seen from the position of the host vehicle M shown in FIG. 3. Furthermore, the targets OB2 and OB3 are located farther away than the target OB1 as seen from the position of the host vehicle M shown in FIG. 3 and the target OB3 is located even farther away than the target OB2.

In the example of FIG. 3, the host vehicle M travels in the lane L1 at a speed VM and the other vehicle m1 travels in the lane L1 in front of the host vehicle M at a speed Vm1. In FIG. 3, a travel trajectory (a movement trajectory) K1 of the other vehicle m1 is shown. The other vehicle m1 is an example of a “preceding mobile object.” In the example of FIG. 3, the host vehicle M is subjected to LKAS control, and automated driving is performed so that the host vehicle M is kept within the travel lane (in other words, so that the host vehicle M is prevented from deviating from the travel lane). In this case, the automated driving control device 100, for example, identifies the travel lane of the host vehicle M on the basis of the recognized marking, generates a target trajectory so that the host vehicle M travels in the center of the identified travel lane, and executes travel control (movement control) including at least steering the host vehicle M so that the host vehicle M travels along the generated target trajectory. In the travel control, feedforward control or feedback control is performed as needed on the basis of the target trajectory and the position of the host vehicle M to adjust the steering angle, speed, and the like of the host vehicle M.

### [First Recognizer 132]

The first recognizer 132 uses an image captured by the camera 10 to recognize a target (a camera target) and a camera marking (a first marking) CL for defining a lane (a movement path) located in a nearby area including a travel direction of the host vehicle M. For example, the first recognizer 132 performs a known analysis process (e.g., edge extraction, extraction of feature quantities of a color, shape, size, and the like, a pattern matching process, a character recognition process, and the like) on an image captured by the camera 10 (hereinafter, a camera image), and recognizes the camera marking CL and camera targets near the road (within a predetermined distance from the road and on the road RD1) on which the host vehicle M is traveling from an image analysis result. When the camera marking CL is recognized, the first recognizer 132 extracts edge points that have a large brightness difference from adjacent pixels in the camera image, and recognizes the camera marking CL in the image plane by connecting the edge points. The first recognizer 132 converts the position of the camera marking CL based on the position of the representative point of the host vehicle M into a vehicle coordinate system (e.g., the XY plane coordinate system in FIG. 3).

In the example of FIG. 3, the first recognizer 132 can recognize the camera markings CL1 to CL3 and the targets OB1 to OB3 on the basis of the camera image. The first recognizer 132 recognizes the position and speed Vm1 of the other vehicle m1, which is a preceding vehicle of the host vehicle M. The other vehicle m1 is also an example of a “target.” The first recognizer 132 may recognize curvatures and the road surface gradients of the lanes L1 and L2 on the basis of the camera image or may recognize curvature variations of the camera markings CL1 to CL3. The curvature variation is, for example, a time change rate of the curvatures of the camera markings CL1 to CL3 recognized by the camera 10 at a distance x [m] forward as seen from the host vehicle M. The first recognizer 132 may recognize an area in which the host vehicle M can travel (move) (or an area without any obstacle such as a physical boundary) as a free space (hereinafter referred to as a camera-free space) on the basis of the recognized camera markings CL and camera targets.

The first recognizer 132 may experience the deterioration of the recognition accuracy of the camera marking CL or the camera target when the target is located at a long distance (a position that is a predetermined distance or more away from the host vehicle M) or according to surrounding situations such as weather (e.g., bad weather such as thunderstorms or direct sunlight), date and time (nighttime or the like), and the occurrence of blind spots due to traffic congestion.

### [Second Recognizer 134]

The second recognizer 134 refers to map information (the first map information 54 and the second map information 62) on the basis of the position information of the host vehicle M acquired by the vehicle sensor 40 or the GNSS receiver 51 and recognizes map markings (second markings) for defining lanes (movement paths) located in a surrounding area including a travel direction of the host vehicle M from the map information.

In the example of FIG. 3, the second recognizer 134 can recognize the map markings ML1 to ML3 and the target OB1 on the basis of the map information. The second recognizer 134 may recognize curvatures and road surface gradients of lanes L1 and L2 from the map information or may recognize curvature variations of the map markings ML1 to ML3. Because a target installed for road construction such as a target OB2 is not reflected in the map information, the target cannot be recognized by the second recognizer 134. The second recognizer 134 cannot recognize the other vehicle m1. The second recognizer 134 can communicate with an external device via the communication device 20 and acquire information indicating that a nearby area of the segment S1 (within a predetermined distance from the segment S1 and including the segment S1) is under construction from the external device.

### [Third Recognizer 136]

The third recognizer 136 recognizes a target (a radar target) located in a nearby area including the travel direction of the host vehicle M on the basis of a detection result of a device (e.g., the radar device 12) other than the camera 10 among detection devices DD. For example, the third recognizer 136 recognizes a position and speed of a radar target (and a distance from the radar target and a direction of the radar target) located in the travel direction of the host vehicle M from the detection result of the radar device 12. The third recognizer 136 may recognize the radar target in the nearby area including the travel direction of the host vehicle M on the basis of the detection result of the LIDAR sensor 14 instead of (or in addition to) the radar device 12.

In the example of FIG. 3, the third recognizer 136 recognizes targets OB1 to OB3 and another vehicle m1 located in the vicinity of the host vehicle M. The third recognizer 136 may recognize an area where the host vehicle M can travel (or an area without any obstacle such as a physical boundary) as a free space (hereinafter referred to as a radar-free space) on the basis of the recognized radar target.

When a reflective object (a reflective area) that reflects radio waves or light is located in a part of a nearby area of a travel segment of the host vehicle M such as a tunnel, under an overpass, or under a bridge, because radio waves and light are diffusely reflected by reflective objects (such as walls in tunnels) and the reflected light excessively increases, the third recognizer 136 recognizes the targets OB1 to OB3 with the deteriorated recognition accuracy. Thus, the third recognizer 136 may also have the deteriorated recognition accuracy according to a surrounding situation like the first recognizer 132. However, the third recognizer 136 can recognize a sidewall near the entrance of a tunnel before entering the tunnel without being affected by diffuse reflection. Therefore, the third recognizer 136 may recognize, for example, a corner (an end) of the entrance of a tunnel as a substitute for a nose target.

### [Determiner 142]

The determiner 142 determines whether or not the camera markings CL1 to CL3 recognized by the first recognizer 132 match the map markings ML1 to ML3 recognized by the second recognizer 134. For example, the determiner 142 derives a degree of match between the markings CL1 and ML1 located closest to the right side of the host vehicle M, a degree of match between the markings CL2 and ML2 located closest to the left side of the host vehicle M, and a degree of match between the markings CL3 and ML3 on the adjacent lane side. When the derived degree of match is greater than or equal to a threshold value, the determiner 142 determines that the camera marking CL and the map marking ML match. When the degree of match is less than the threshold value, the determiner 142 determines that the camera marking CL and the map marking ML do not match. The determination of whether or not there is a match may be made repeatedly at a predetermined timing or cycle.

For example, the determiner 142 superimposes the camera markings CL1, CL2, and CL3 and also superimposes the map markings ML1, ML2, and ML3 on the basis of a position of a representative point of the host vehicle M in a vehicle coordinate system plane (an XY plane). When the markings to be compared (the markings CL1 and ML1, the markings CL2 and ML2, and the markings CL3 and ML3) are determined, the determiner 142 determines that the markings match if the degrees of match of all the markings are greater than or equal to the threshold value and determines that the markings do not match if at least one degree of match of the markings is less than the threshold value.

Here, the degree of match in the above-described match determination is, for example, a degree of deviation (a matching distance or a deviation of a movement path width direction) in a road width direction (a movement path width direction, a lateral direction, or a Y-axis direction in the drawing). In addition, in the example of FIG. 3, the match determination may be made using a lateral position deviation amount D1 between the markings CL1 and ML1, a lateral position deviation amount D2 between the markings CL2 and ML2, and a lateral position deviation amount D3 between the markings CL3 and ML3 or the match determination may be made using an average value, a maximum value, or a minimum value of the deviation amounts D1, D2, and D3.

The degree of match may be a degree of a magnitude of an angle formed by the two markings to be compared (a degree of deviation according to a deviation angle), for example, instead of (or in addition to) the above-described lateral position deviation amount. For example, the greater the degree of deviation, the smaller the degree of match. Although only the angle θ formed by the markings CL2 and ML2 is shown in the example of FIG. 3, the match determination may be made using the angle formed by the markings CL1 and ML1 or the angle formed by the markings CL3 and ML3 or the match determination may be made using an average value, a maximum value, or a minimum value of the angles θ.

The degree of match may be a degree (a magnitude) of curvature variation difference between the markings, instead of (or in addition to) the degree of lateral position deviation or the degree of deviation according to the deviation angle formed by the markings described above. The curvature variation is mainly used when the lane is a curved road as shown in FIG. 3. For example, the determiner 142 may make the match determination using a curvature variation difference between the markings CL1 and ML1, a curvature variation difference between the markings CL2 and ML2, and a curvature variation difference between the markings CL3 and ML3 or may make the match determination using an average value, a maximum value, or a minimum value of the differences.

The determiner 142 determines whether or not the recognition accuracy of the first recognizer 132 or the third recognizer 136 has deteriorated. For example, the determiner 142 determines whether or not a travel scene (a travel situation) of the host vehicle M is a low-accuracy scene in which the recognition accuracy is likely to deteriorate in each of the first recognizer 132 and the third recognizer 136 in advance, and determines that the recognition accuracy has deteriorated when it is determined that the host vehicle M is traveling in a low-accuracy scene. For example, travel scenes of nearby areas of points where nose targets such as a tunnel entrance, a branch end, and a median strip end are located in the travel direction and travel scenes of road surface gradients, bad weather, and the like are likely to affect the camera image, and therefore are low-accuracy scenes (camera-specific low-accuracy scenes) for recognition by the first recognizer 132. Travel scenes at points where reflective objects are located, such as inside a tunnel, under a bridge, and under an overpass, affect detection results using the radar device 12, and therefore are low-accuracy scenes (radar-specific low-accuracy scenes) for recognition by the third recognizer 136. Therefore, when the travel scene of the host vehicle M is a low-accuracy scene, the determiner 142 determines that the recognition accuracy of the target recognizer has deteriorated. The determiner 142 may determine whether or not the host vehicle M is traveling in a low-accuracy scene (whether or not the current travel scene is a low-accuracy scene).

### [Identifier 144]

The identifier 144 identifies the travel lane of the host vehicle M on the basis of the recognition results of the first to third recognizers 132 to 136 and the determination result of the determiner 142. For example, when the determiner 142 determines that the camera marking CL and the map marking ML match, the identifier 144 identifies a lane defined by the camera markings CL1 and CL2 or a lane defined by the map markings ML1 and ML2 as the travel lane of the host vehicle M.

The identifier 144 may estimate a physical boundary line on the basis of the camera target recognized by the first recognizer 132 and the radar target recognized by the third recognizer 136 and identify the travel lane of the host vehicle M on the basis of the estimated physical boundary line, the camera marking, and the map marking. Specific processing content of the determiner 142 and the identifier 144 will be described below.

### [Travel Controller 146]

The travel controller 146 decides driving control for the host vehicle M on the basis of the recognition results of the first to third recognizers 132 to 136 and the travel lane identified by the identifier 144 and generates a target trajectory based on the decided driving control. “Deciding driving control” may include, for example, deciding the content (type) of driving control and deciding whether or not to execute (suppress) driving control. “Executing driving control” may include, for example, continuing driving control that is already being executed, in addition to switching and executing the content of driving control. Suppressing driving control may include lowering the automation level of driving control as well as executing driving control.

For example, when the LKAS control is executed as the driving control (automated driving), the travel controller 146 controls at least the steering of the host vehicle M so that the representative point of the host vehicle M passes through the center of the travel lane on the basis of the travel lane identified by the identifier 144 and causes the host vehicle M to travel. When the determiner 142 determines that the camera marking CL and the map marking ML do not match and the recognition accuracy of the first recognizer 132 and the third recognizer 136 have deteriorated, the travel controller 146 ends the driving control of the host vehicle M and switches the driving to manual driving of the driver or executes control for lowering the automation level of the automated driving. The automation level includes, for example, a first level, a second level having a lower degree of automation of the driving control than the first level, and a third level having a lower degree of automation of the driving control than the second level. The automation level may include a fourth level having a lower degree of automation of the driving control than the third level. The automation level may be a level determined by standardized information, laws, or the like or may be an index value set independently thereof. Therefore, the types, content, and number of automation levels are not limited to the following examples. A low degree of automation of driving control, for example, indicates that an automation rate in driving control is low and the task imposed on the driver is large (or heavy). A low degree of automation of driving control indicates that the degree to which the automated driving control device 100 controls the steering or speed of the host vehicle M is low (or the degree to which the driver needs to intervene in the steering or speed operation is high). Tasks imposed on the driver include, for example, monitoring the surroundings of the host vehicle M, operating the driving operation element, and the like. The operation of the driving operation element includes, for example, a state in which the driver is gripping the steering wheel (hereinafter, a hands-on state). Tasks imposed on the driver are, for example, tasks for the driver (driver-specific tasks) that are necessary for maintaining the automated driving of the host vehicle M. Therefore, when the driver cannot perform the imposed task, the automation level will be lowered.

At the first level, there is no task imposed on the driver (the task imposed on the driver is the lightest), so that, for example, driving control is allowed in a state in which the driver of the host vehicle M is not gripping the steering wheel (hereinafter referred to as a hands-off state). At the second level, the task imposed on the driver is, for example, monitoring the surroundings (particularly, the front) of the host vehicle M. At the third level, the task imposed on the driver is, for example, a hands-on state in addition to monitoring the surroundings of the host vehicle M. At the fourth level, the task imposed on the driver is, for example, an operation for controlling the steering and speed of the host vehicle M by the driving operation element 80 in addition to monitoring the surroundings of the host vehicle M and the hands-on state. In other words, at the fourth level, the driver is in a state in which he or she can immediately take over driving and the task imposed on the driver is the heaviest. The content of the driving control at each automation level and the tasks imposed on the driver are not limited to the above-described examples. The automated driving control device 100 executes driving control at any one of the first to fourth levels on the basis of the surrounding situation of the host vehicle M and the task being executed by the driver. The execution content of the driving control is output from the HMI 30 by the HMI controller 180 and the driver is notified thereof.

### [Specific Processing Content of Determiner 142 and Identifier 144]

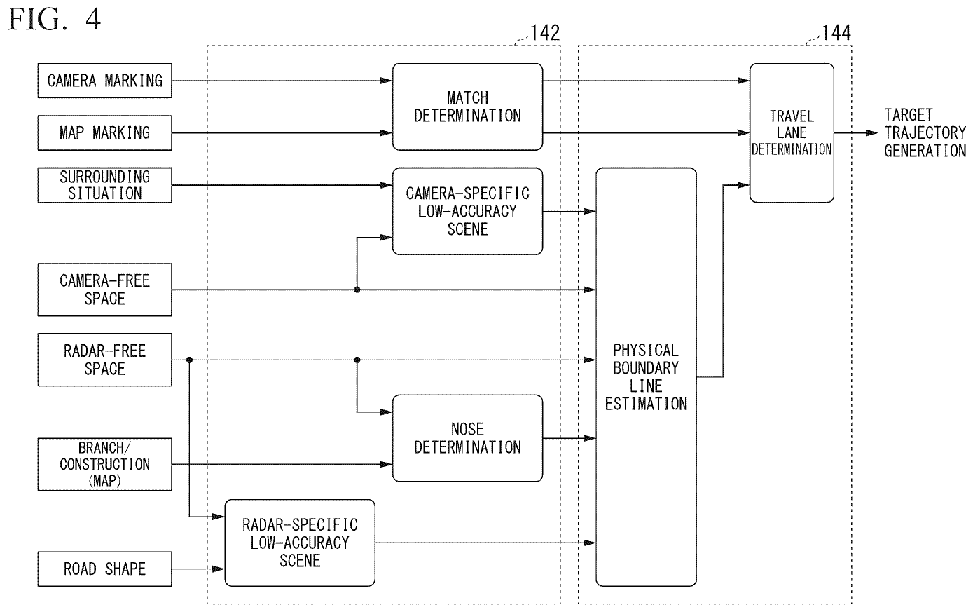

Next, specific processing content of the determiner 142 and the identifier 144 will be described. FIG. 4 is an explanatory diagram of the identification of a travel lane based on the recognition accuracy. As shown in the example of FIG. 4, the identifier 144 identifies the travel lane of the host vehicle M on the basis of the determination result of the determiner 142 and on the basis of information of the camera marking CL and the map marking ML and the result of estimating the physical boundary line. Here, the determiner 142 makes the determination of a low-accuracy scene based on various types of information and the determination of whether or not a predetermined target (e.g., a nose target) has been recognized as a recognition result, in addition to the match determination between the camera marking CL and the map marking ML, on the basis of various types of input information. The low-accuracy scene includes a camera-specific low-accuracy scene in which the recognition accuracy of the first recognizer 132 using the camera image has deteriorated and a radar-specific low-accuracy scene in which the recognition accuracy of the third recognizer 136 using the detection result of the radar device 12 has deteriorated.

### [Camera-Specific Low-Accuracy Scene Detection]

When the camera-specific low-accuracy scene is determined, the determiner 142, for example, acquires information about the surrounding situation (the travel scene) of the host vehicle M, and determines that the surrounding situation is a camera-specific low-accuracy scene when the acquired surrounding situation satisfies a predetermined condition. The predetermined condition includes the presence of a nose target such as a tunnel entrance or a branch end (or a merge end) in the travel direction of the host vehicle M (within a predetermined distance therefrom), the presence of a road surface gradient of a predetermined value or more, a surrounding weather state indicating specific weather (e.g., thunderstorm, heavy rain, typhoon, or snow), and the like. A road shape such as the presence or absence of a tunnel, a branch point, a merge point, or a road surface gradient may be acquired from map information. The weather state may be acquired from a weather acquisition sensor included in the vehicle sensor 40 or the weather state may be acquired on the basis of position information of the host vehicle M from an external device connected via the communication device 20. In the determination of the low-accuracy scene, in addition to (or instead of) the information about the surrounding situation, information about the camera-free space based on a camera image captured by the camera 10 may be used.

### [Nose Determination]

The determiner 142 determines the presence or absence of a nose target on the basis of the radar-free space based on the detection result of the radar device 12 and/or map information such as a branch or a construction segment, and the surrounding situation acquired from an external device via the communication device 20. For example, because a hard nose at a branch end is a road structure (having a three-dimensional shape), it is easier to determine the presence or absence from the detection result of the radar device 12 than from the recognition from a camera image. Therefore, the determiner 142 makes the above-described nose determination using the recognition result of the third recognizer 136 performing a recognition process from the detection result of the radar device 12 instead of the recognition result of the first recognizer 132 based on the camera image. In the nose determination, instead of (or in addition to) the presence or absence of a nose target, it may be determined whether or not a physical boundary (or a boundary line) has been recognized near a branch point or the like.

### [Radar-Specific Low-Accuracy Scene Determination]

When a radar-specific low-accuracy scene is determined, the determiner 142, for example, refers to map information on the basis of the position information of the host vehicle M, and acquires a road shape corresponding to the position of the host vehicle M acquired from the map information. Also, when the acquired road shape around the host vehicle is a predetermined shape, it is determined that the scene is a radar-specific low-accuracy scene. The predetermined shape is a tunnel, under a bridge, under an overpass, or the like. For example, in a tunnel or under an overpass, there is a possibility that the position of a radar target or the like cannot be correctly recognized because there are too many reflections of radio waves (radar) due to reflective objects such as the ceiling and sidewalls. Therefore, in the case of traveling in such a road shape, it is determined that the current travel scene of the host vehicle M is a radar-specific low-accuracy scene. The determiner 142 may determine that the scene is not a radar-specific low-accuracy scene.

The identifier 144, for example, estimates a physical boundary line (a marking associated with the extension direction of the physical boundary) around the host vehicle M on the basis of the above-described information about the camera-free space and the radar-free space, the result of determining the camera-specific low-accuracy scene, the result of determining the radar-specific low-accuracy scene, the determination result of the nose determination, and the like. For example, the identifier 144 estimates a physical boundary line from a matching area by combining the camera-free space and the radar-free space. When the surrounding situation (the travel scene) of the host vehicle M is a radar-specific low-accuracy scene instead of a camera-specific low-accuracy scene, the identifier 144 may estimate a physical boundary line on the basis of a position of a camera target (e.g., the target OB1 shown in FIG. 3) recognized using a camera image. When the surrounding situation of the host vehicle M is a camera-specific low-accuracy scene and is not a radar-specific low-accuracy scene, the identifier 144 may estimate a physical boundary line on the basis of a radar target (e.g., the targets OB1 to OB3) acquired by the radar device 12. When the surrounding situation is neither a camera-specific low-accuracy scene nor a radar-specific low-accuracy scene, the identifier 144 may estimate the physical boundary line by prioritizing the recognition result from the camera image. Thereby, while the recognition result from the camera image is usually prioritized, the recognition of the travel lane can be complemented by the detection result of the radar device 12 in a situation where the recognition accuracy of the camera image deteriorates.

Here, as conditions for estimating the physical boundary line using the detection result of the radar device 12, the camera-specific low-accuracy scene, the nose determination result, and the like may be used, but there is a possibility that the recognition accuracy (e.g., the accuracy of information about branch points and the like) of the second recognizer 134 will be poor when the map information has not been updated (e.g., when the information is older than the current information by a predetermined period of time or more). Therefore, in the embodiment, recognition is always performed by the third recognizer 136, and the physical boundary line may be estimated using the detection result of the radar device 12 when the position of the radar target or the position of the preceding vehicle (a travel trajectory or the like) recognized by the third recognizer 136 deviates from the camera target recognized on the basis of a match determination result between the camera marking CL and the map marking ML, the camera marking CL, or the camera image by a predetermined value or more.

### [Processes of Identifier 144 and Travel Controller 146]

The identifier 144 identifies a travel lane of the host vehicle M on the basis of information about the result of estimating the physical boundary line and information about the camera marking CL and the map marking ML (including a match determination result). The travel controller 146 generates a target trajectory of the host vehicle M on the basis of the travel lane identified by the identifier 144. At least some of the functions of the identifier 144 may be included in the travel controller 146.

For example, in the segment S1 shown in FIG. 3, because the markings for defining the lanes L1 and L2 are not drawn due to the influence of a construction segment or the like, some camera markings are not recognized and it is determined that the camera marking CL and the map marking ML do not match by the match determination. In a situation such as bad weather, the targets OB2 and OB3 and the other vehicle m1 located far from the host vehicle M cannot be recognized from the camera image. Under such a situation, the lanes defined by the camera markings CL1 and CL3 are determined to be the travel lanes of the host vehicle M when the recognition result of the third recognizer 136 is not used and travel control in which the host vehicle Mis temporarily steered to the center of the road RD1 including the lanes L1 and L2 is executed when the host vehicle M is under LKAS control. Furthermore, if the host vehicle M approaches the targets OB2 and OB3 and can be recognized from the camera image, travel control in which the host vehicle M is steered to travel in the center of the lane L1 according to the physical boundary line estimated by the targets OB2 and OB3 is executed. Thus, the host vehicle M behaves unsteadily in the segment S1.

Therefore, when the determiner 142 determines that the markings do not match, the identifier 144 in the embodiment identifies the travel lane of the host vehicle M on the basis of the radar targets OB1 to OB3 recognized by the third recognizer 136 (or the physical boundary line estimated on the basis of the target). For example, in the case of the road shape shown in FIG. 3, because the targets OB1 to OB3 and the other vehicle m1 are recognized by the third recognizer 136, the identifier 144 estimates a physical boundary line based on the extension direction of the target OB1 or estimates a physical boundary line extended from the position of the target OB3 in a predetermined direction (e.g., an extension direction of the target OB1 or an extension direction of a travel trajectory K1 of the other vehicle m1). The physical boundary line may be estimated in the front-rear direction (the front side and rear side of the target OB3 as seen from the host vehicle M) from the position of the target OB3. Because the target OB2 is not a nose target, it is not necessary to estimate a physical boundary line based on the target OB2. Also, the identifier 144 identifies the travel lane in the segment S1 using the estimated physical boundary (e.g., a physical boundary based on the target OB3 that is not included in the camera targets). In this case, in addition to the physical boundary line, information about the camera markings CL and the map markings ML may be used and information about the result of estimating the physical boundary line may be used to correct (or complement) the camera markings CL and the map markings ML.

Thereby, the lane L1 can be more accurately identified even in a segment where the camera marking CL and the map marking ML do not match, and stable travel control can be continued by suppressing swaying of the host vehicle M in the segment S1 even if LKAS control is executed to cause the host vehicle M to travel along a target trajectory for traveling in the center of the lane. The identifier 144 may identify a travel lane on the basis of the radar target when a target not recognized by the first recognizer 132 is recognized by the third recognizer 136 (when the target is present among the radar targets) regardless of a match determination result of the determiner 142 and may execute travel control of the host vehicle M in accordance with the identified travel lane.

For example, in the embodiment, the travel controller 146 may control the traveling of the host vehicle M in accordance with the travel lane (the movement path) identified based on the radar target recognized by the third recognizer 136 when the radar target recognized by the third recognizer 136 (e.g., the target OB3 not recognized by the first recognizer 132) is recognized inside the road RD1 in the width direction as seen from the host vehicle M, compared to the camera target (e.g., the target OB1) recognized by the first recognizer 132. Thereby, because the radar target has higher accuracy in identifying the travel lane (movement path) when a radar target is located at a closer position, it is possible to suppress the swaying of the host vehicle M and continue stable travel control by identifying the travel lane using this information.

Furthermore, in the embodiment, when the radar target recognized by the third recognizer 136 is recognized on the inward side of the road RD1 (i.e., within the road RD1) in the width direction as seen from the host vehicle M, compared to the camera marking CL or the camera target, and is located a distant position (at a position that is a predetermined distance away therefrom) as seen from the host vehicle M, the travel controller 146 may control the traveling of the host vehicle M in accordance with the travel lane identified on the basis of the radar target recognized by the third recognizer 136. Thereby, it is possible to more appropriately identify the travel lane in a close range using a radar target located at a distant position where the recognition accuracy based on the camera image deteriorates.

In the embodiment, when the radar target recognized by the third recognizer 136 is another vehicle m1 traveling in front of the host vehicle M, the identifier 144 may identify the travel lane on the basis of the position of the other vehicle m1 and the travel trajectory K1 of the other vehicle m1. In this case, as described above, it is estimated that the other vehicle m1 is traveling in the center of the lane, and a physical boundary line is estimated at a position that is a predetermined distance from the travel trajectory K1 in the left-right direction (the lateral direction) under the assumption that the travel trajectory K1 of the other vehicle m1 is the center of the lane. Also, the identifier 144 identifies the lane defined by the estimated left and right physical boundary lines as the travel lane. Even if the other vehicle m1 is not recognized from the camera image, a travel lane (a travel path) can be accurately identified by the preceding vehicle detected from the radar device 12.

In the embodiment, when the target recognized by the third recognizer 136 is a nose target (a soft nose or a hard nose), the identifier 144 may identify the travel lane of the host vehicle M on the basis of the position of the nose target or the like. In this case, as described above, because the target OB2 shown in FIG. 3 is not a nose target, a physical boundary line based on the target OB2 is not estimated. Thereby, even if the nose cannot be recognized from the camera image due to surrounding conditions such as bad weather, the travel lane can be more accurately identified according to a change in a road structure such as a branch or construction segment by the nose target included in the radar target.

In the embodiment, when the radar target recognized by the third recognizer 136 is a tunnel sidewall, the identifier 144 may identify the travel lane of the host vehicle M using a physical boundary line estimated by the left and right sidewalls in the tunnel. Thereby, even if the tunnel sidewall cannot be recognized from the camera image due to the surrounding situation or the like, the travel lane of the host vehicle M can be more accurately identified by position information of a physical object (a tunnel sidewall) obtained from a detection result of the radar device 12. In the first recognizer 132 that performs recognition using the camera image, the recognition accuracy deteriorates due to the influence of the shadow caused by the tunnel near the tunnel entrance. In the third recognizer 136 that performs recognition using the radar device 12, the recognition accuracy deteriorates due to the influence of the diffuse reflection by the wall inside the tunnel or the like. Therefore, for example, when the host vehicle M travels near a tunnel (and inside the tunnel), the identifier 144 may identify the travel lane of the host vehicle M using an appropriate recognition result in accordance with these low-accuracy scenes.

In the embodiment, the determiner 142 may determine whether or not the recognition accuracy of the first recognizer 132 has deteriorated and the travel controller 146 may control the traveling of the host vehicle M in accordance with the travel lane identified using the radar target recognized by the third recognizer 136 when it is determined that the recognition accuracy of the first recognizer 132 has deteriorated. In this case, for example, even if the determiner 142 determines that the camera marking CL and the map marking ML match, when it is determined that the recognition accuracy of the first recognizer 132 has deteriorated, the travel lane is identified on the basis of the radar target. Furthermore, in this case, even if the radar targets do not include targets not recognized by the first recognizer 132, the travel lane may be identified on the basis of the radar target.

In the embodiment, the identifier 144 may normally prioritize the recognition result of the first recognizer 132 to identify the travel lane and may prioritize the recognition result of the third recognizer 136 to identify the travel lane when it is determined that the recognition accuracy of the first recognizer 132 has deteriorated. Thereby, it is possible to correct or complement the recognition of the travel lane using the radar target when the recognition accuracy using the camera image has deteriorated. When it is determined that the recognition accuracy of the third recognizer 136 has deteriorated, the identifier 144 may prioritize the recognition result of the first recognizer 132 to identify the travel lane.

In the embodiment, the identifier 144 may adjust the priority of the target recognition result of the first recognizer 132 and the target recognition result of the third recognizer 136 in accordance with a distance between the target located in the travel direction of the host vehicle M and the host vehicle M and identify the travel lane on the basis of the recognition result with the higher priority. Thereby, it is possible to more accurately identify the travel lane by appropriately switching the priority of the recognition result.

In the embodiment, when a marking is located within a predetermined distance from the radar target, the travel controller 146 may perform travel control on the basis of the marking. For example, when the radar target is used to identify the travel lane, the target trajectory is generated so that the host vehicle M travels in the extension direction of the marking (the camera marking CL2 or the map marking ML2 in the example of FIG. 3) near the radar target. Thereby, it is possible to identify the marking with higher accuracy on the basis of the radar target.

In the embodiment, even if the determiner 142 determines that the camera marking CL and the map marking ML match, when a marking is located within a predetermined distance from the radar target, the travel controller 146 may execute travel control of the host vehicle M on the basis of the marking. Even if it is determined that the camera marking CL and the map marking ML match, for example, it is possible to accurately identify the travel lane even if it is erroneously determined that they match in a situation where the recognition accuracy of the first recognizer 132 has deteriorated on the basis of an influence of bad weather or the like by adopting a marking corresponding to the radar target.

Even if the camera marking CL recognized by the first recognizer 132 and the camera target recognized by the first recognizer 132 are located within a predetermined distance, the travel controller 146 may execute travel control of the host vehicle M on the basis of a marking when the marking is located within the predetermined distance from the radar target. For example, even if the camera marking CL is recognized within the predetermined distance from the camera target recognized by the first recognizer 132, the travel lane can be identified with higher accuracy because the camera target and the camera marking CL are not adopted in a state in which the recognition accuracy of the first recognizer 132 has deteriorated by adopting the marking corresponding to the radar target.

In an embodiment, when the determiner 142 determines that the scene is the camera-specific low-accuracy scene and that the scene is the radar-specific low-accuracy scene, the travel controller 146 may end driving control such as LKAS control and perform control for switching driving to manual driving (or lower the automation level) without identifying a travel lane. In an embodiment, when the determiner 142 determines that the camera marking CL and the map marking ML do not match and there is no target not recognized by the first recognizer 132 among the radar targets, the travel controller 146 ends driving control such as LKAS control and perform control for switching driving to manual driving (or lower the automation level).

### [Processing Flow]

Hereinafter, a process executed by the automated driving control device 100 of the embodiment will be described. Hereinafter, a travel control process based on the surrounding situation of the host vehicle M among the processes executed by the automated driving control device 100 will be mainly described. In addition, it is assumed that the host vehicle M is executing predetermined driving control (e.g., LKAS control or the like) when the flow starts. The process to be described below may be iteratively executed at a predetermined timing or at a predetermined cycle (e.g., while the driving control by the automated driving control device 100 is being executed).

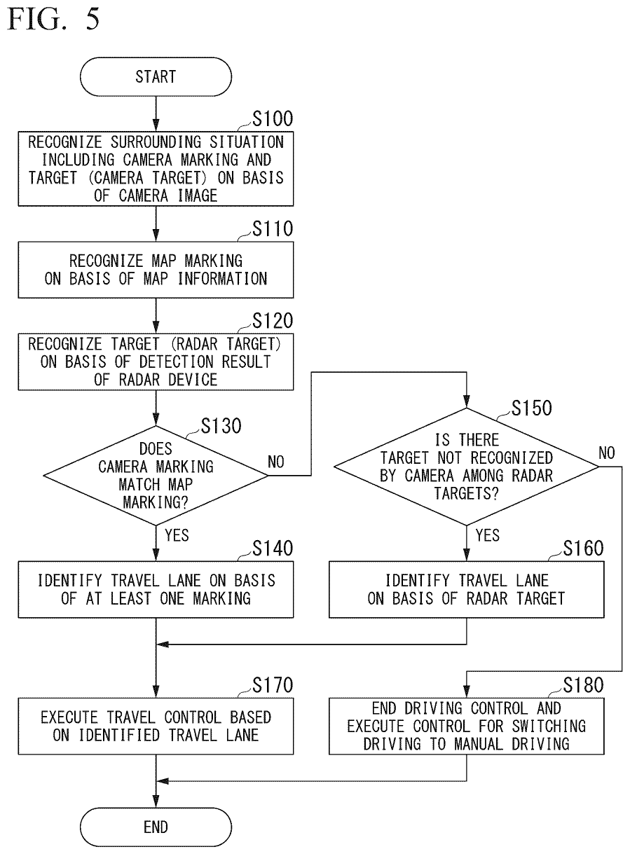

FIG. 5 is a flowchart showing an example of the flow of the travel control process in the embodiment. In the example of FIG. 5, the first recognizer 132 recognizes a surrounding situation including a marking (a camera marking CL) and a target located in a nearby area including a travel direction of the host vehicle M on the basis of the camera image (step S100).

Subsequently, the second recognizer 134 refers to map information using the position information of the host vehicle M and recognizes a marking (a map marking ML) located near the host vehicle M on the basis of the map information (step S110). In the processing of step S110, information about a target included in the map information and the like may be recognized in addition to the map marking. Subsequently, the third recognizer 136 recognizes a target located in a nearby area including the travel direction of the host vehicle M on the basis of the detection result of the radar device 12 (and/or the LIDAR sensor 14) (step S120).

Subsequently, the determiner 142 determines whether or not the camera marking CL and the map marking ML match (step S130). When it is determined that they match, the identifier 144 identifies a travel lane on the basis of at least one of the camera marking CL and the map marking ML (step S140). When it is determined that they do not match in the processing of step S130, the determiner 142 determines whether or not there is a target not recognized by the camera 10 among radar targets (step S150). In the processing of step S140, for example, the camera target recognized by the first recognizer 132 and the radar target recognized by the second recognizer 134 are compared and it is determined whether or not there is a target not recognized by the first recognizer 132 among the radar targets.

When it is determined that there is a target not recognized by the camera 10 among the radar targets, the identifier 144 identifies the travel lane of the host vehicle M on the basis of the radar targets (step S160). After the processing of step S140 or S160, the travel controller 146 generates a target trajectory of the host vehicle M so that the host vehicle M travels in the center of the identified travel lane and causes the host vehicle M to travel along the generated target trajectory (step S170). When it is determined that there is a target not recognized by the camera 10 among the radar targets in the processing of step S150, the travel controller 146 ends the driving control being executed and executes control for switching driving to manual driving (step S180). Thereby, the process of the present flowchart ends.

The travel control process of the embodiment is not limited to the process shown in FIG. 5. For example, when the identifier 144 determines that there is a target not recognized by the camera 10 among radar targets, regardless of whether or not the camera marking CL and the map marking ML match, the identifier 144 may identify the travel lane of the host vehicle M on the basis of the radar targets. In the processing of step S180, instead of only switching the driving to manual driving, control may be performed to lower the automation level. Furthermore, the determiner 142 may determine a camera-specific low-accuracy scene or a radar-specific low-accuracy scene and the travel lane of the host vehicle M may be identified using a target with higher priority between the camera target and the radar target on the basis of a determination result.

### Modified Example

In the above-described embodiment, instead of determining whether or not the camera markings CL and the map markings ML match, it may be determined whether or not the camera markings CL and the map markings ML deviate from each other. In addition to the above-described travel control, at least one of the steering and the speed of the host vehicle M may be controlled to avoid contact with a physical object recognized by the recognizer 130. Although the travel control during execution of the LKAS control has been mainly described in the above-described embodiment, the present invention can also be applied to other driving controls such as the ALC control.

According to the above-described embodiment, the automated driving control device (an example of a mobile object control device) 100 includes: the first recognizer 132 configured to recognize a target (a camera target) and a first marking (a camera marking) for defining a travel lane (a movement path) located in a travel direction of the host vehicle (an example of a mobile object) M using an image captured by the camera (an example of an imager) 10; the second recognizer 134 configured to recognize a map marking (a second marking) for defining a travel lane near the host vehicle M from map information on the basis of position information of the host vehicle M; the third recognizer 136 configured to recognize the target (a radar target) in the travel direction of the host vehicle M using the radar device 12; the determiner 142 configured to determine whether or not the camera marking matches the map marking; and the travel controller (an example of a movement controller) 146 configured to control traveling of the host vehicle M on the basis of a determination result of the determiner 142, wherein, when the third recognizer 136 recognizes the target not recognized by the first recognizer 132, the travel controller 146 controls movement of the host vehicle M in accordance with the travel lane (the movement path) identified on the basis of the target recognized by the third recognizer 136, whereby it is possible to execute more appropriate movement control in accordance with a recognition situation of surroundings of the host vehicle M. Also, the present invention contributes to the development of a sustainable transportation system.

Specifically, according to the embodiment, a travel path is selected on the basis of targets (physical boundaries, preceding vehicles, and the like) recognized by the radar, such that it is possible to further improve the accuracy of travel path selection by utilizing the boundaries detected by the radar. For example, because the radar device 12 can detect targets without being affected by branching, bad weather, gradients, and the like, it is possible to detect targets more accurately and stably than using a camera image even if the beginning of a physical boundary (a branching hard nose) or a preceding vehicle is located at a distant position.

According to the embodiment, even if the travel path cannot be accurately identified using only the camera and/or map information, the travel path can be identified using radar targets that cannot be recognized by the camera, thereby suppressing swaying of the host vehicle M and continuing stable travel control. According to the embodiment, when a radar target is located at a closer position, because the radar target may be more accurate in identifying the travel path, it is possible to suppress swaying of the host vehicle M in driving control such as LKAS control and continue more stable travel control by identifying the travel path using information thereof.

The embodiment described above can be represented as follows.

A mobile object control device including:
a storage medium storing computer-readable instructions; and
a processor connected to the storage medium, the processor executing the computer-readable instructions to:
recognize a target and a first marking for defining a movement path located in a travel direction of a mobile object using an image captured by an imager;
recognize a second marking for defining a movement path near the mobile object from map information on the basis of position information of the mobile object;
recognize the target in the travel direction of the mobile object using a radar device;
determine whether or not the first marking matches the second marking;
control movement of the mobile object on the basis of a determination result; and
control movement of the mobile object in accordance with the movement path identified on the basis of the target recognized using the radar device when the target not recognized by a recognition process using the image is recognized by a recognition process using the radar device.

Although modes for carrying out the present invention have been described using embodiments, the present invention is not limited to the embodiments and various modifications and substitutions can also be made without departing from the scope and spirit of the present invention.

What is claimed is:

1. A mobile object control device comprising:
a first recognizer configured to recognize a target and a first marking for defining a movement path located in a travel direction of a mobile object using an image captured by an imager;
a second recognizer configured to recognize a second marking for defining a movement path near the mobile object from map information on the basis of position information of the mobile object;
a third recognizer configured to recognize the target in the travel direction of the mobile object using a radar device;
a determiner configured to determine whether or not the first marking matches the second marking; and
a movement controller configured to control movement of the mobile object on the basis of a determination result of the determiner,
wherein, when the third recognizer recognizes the target not recognized by the first recognizer, the movement controller controls movement of the mobile object in accordance with the movement path identified on the basis of the target recognized by the third recognizer.

2. The mobile object control device according to claim 1, wherein the movement controller controls the movement of the mobile object in accordance with the movement path identified on the basis of the target recognized by the third recognizer when the target recognized by the third recognizer is recognized on an inward side of the movement path in a width direction as seen from the mobile object, compared to the target recognized by the first recognizer.

3. The mobile object control device according to claim 2, wherein the target recognized by the third recognizer is located farther away from the mobile object than the first marking or the target recognized by the first recognizer.

4. The mobile object control device according to claim 3, wherein the target recognized by the third recognizer includes a preceding mobile object moving in front of the mobile object.

5. The mobile object control device according to claim 3, wherein the target recognized by the third recognizer includes a target indicating a branch point, a merge point, or a construction segment end of the movement path.

6. The mobile object control device according to claim 3, wherein the target recognized by the third recognizer includes a tunnel sidewall.

7. The mobile object control device according to claim 1,
wherein the determiner determines whether or not recognition accuracy of the first recognizer has deteriorated, and
wherein the movement controller controls the movement of the mobile object in accordance with the movement path identified using the target recognized by the third recognizer when it is determined that the recognition accuracy has deteriorated.

8. The mobile object control device according to claim 1, wherein the movement controller controls the movement of the mobile object on the basis of a marking located within a predetermined distance from the target recognized by the third recognizer.

9. The mobile object control device according to claim 8, wherein the movement controller controls the movement of the mobile object on the basis of the marking when the marking is located within the predetermined distance from the target recognized by the third recognizer even if the determiner determines that the first marking matches the second marking.

10. The mobile object control device according to claim 8, wherein the movement controller controls the movement of the mobile object on the basis of the marking when the marking is located within the predetermined distance from the target recognized by the third recognizer even if positions of the first marking and the target recognized by the first recognizer are within the predetermined distance.

11. The mobile object control device according to claim 1, wherein the movement controller adjusts priorities of a recognition result of the first recognizer and a recognition result of the third recognizer in accordance with a distance between the target located in the travel direction of the mobile object and the mobile object and controls the movement of the mobile object in accordance with the movement path identified on the basis of a recognition result of higher priority.

12. A mobile object control method comprising:
recognizing, by a computer, a target and a first marking for defining a movement path located in a travel direction of a mobile object using an image captured by an imager;
recognizing, by the computer, a second marking for defining a movement path near the mobile object from map information on the basis of position information of the mobile object;
recognizing, by the computer, the target in the travel direction of the mobile object using a radar device;
determining, by the computer, whether or not the first marking matches the second marking;
controlling, by the computer, movement of the mobile object on the basis of a determination result; and
controlling, by the computer, movement of the mobile object in accordance with the movement path identified on the basis of the target recognized using the radar device when the target not recognized by a recognition process using the image is recognized by a recognition process using the radar device.

13. A computer-readable non-transitory storage medium storing a program for causing a computer to:
recognize a target and a first marking for defining a movement path located in a travel direction of a mobile object using an image captured by an imager;
recognize a second marking for defining a movement path near the mobile object from map information on the basis of position information of the mobile object;
recognize the target in the travel direction of the mobile object using a radar device;
determine whether or not the first marking matches the second marking;
control movement of the mobile object on the basis of a determination result; and
control movement of the mobile object in accordance with the movement path identified on the basis of the target recognized using the radar device when the target not recognized by a recognition process using the image is recognized by a recognition process using the radar device.
